(19) United States
(12) Patent Application Publication
(10) Pub. No.: US 2025/0113776 A1
(43) Pub. Date: Apr. 10, 2025

(54) SYSTEMS AND METHODS FOR CROP STABILIZATION

(71) Applicant: Zordi, Inc., Boston, MA (US)

(72) Inventors: Ryan R. Knopf, Morehead, KY (US); Ryan Wasserman, Morehead, KY (US); Wesley Bird, Morehead, KY (US); Zi Chan, Morehead, KY (US); D Sterling Gray, Morehead, KY (US); Joshua Aaron Lessing, Morehead, KY (US); Daniel Bassett, Morehead, KY (US)

(21) Appl. No.: 18/728,798

(22) PCT Filed: Jul. 29, 2022
(86) PCT No.: PCT/US2022/074295

§ 371 Date: Jul. 12, 2024

Related U.S. Application Data
(60) Provisional application No. 63/231,567, filed on Aug. 10, 2021.
(60) Provisional application No. 63/266,798, filed on Jan. 14, 2022.

(51) Int. Cl. A01D 46/30; A01D 46/24

(52) U.S. Cl. CPC A01D 46/30; A01D 46/24

(57) ABSTRACT

Onboard and/or offboard crop stabilization for reducing movement within an agricultural environment to enhance robotic manipulation for crop harvesting.

### BACKGROUND

Agricultural technology is a sector of significant commercial interest. Examples of some emerging agricultural technologies pertain to automated farming tools for crop care and irrigation. Automation of harvesting operations poses significant challenges. Aspects and embodiments disclosed herein relate to systems and methods for harvesting agricultural fruits and vegetables using a semi-autonomous mobile robot.

### BRIEF DESCRIPTION OF THE DRAWINGS

Embodiments of this disclosure will now be described, by way of non-limiting example, with reference to the accompanying drawings.

FIG. 1 illustrates a rack and pinion extension mechanism for a portion of crop stabilization system;

FIG. 2 illustrates an example of an on-board wire/cable deployment crop stabilization subsystem of a robotic crop harvester;

FIG. 3 illustrates an example of an on-board wire/cable deployment crop stabilization subsystem of a robotic crop harvester;

FIG. 4 illustrates an embodiment of an onboard stabilization system of a robotic fruit harvesting system including a pivoting comb configured to engage a rear side of a plant during harvesting of a crop from the plant;

FIGS. 5A-5C illustrate an embodiment of an onboard stabilization system of a robotic fruit harvesting system including interdigitating pivoting combs configured to engage a rear side of a plant during harvesting of a crop from the plant;

FIGS. 6A-6C illustrate an embodiment of an onboard stabilization system of a robotic fruit harvesting system including dual onboard stabilizers;

FIG. 7 is a side view of one embodiment of an onboard stabilization system of a robotic fruit harvesting system;

FIG. 8 is a top view of the onboard stabilization system of FIG. 7;

FIG. 9 illustrates an example of horizontal wire-based off-board plant stabilization sub-system;

FIG. 10 displays different cross-sectional profiles of embodiments of offboard stabilization system structures;

FIG. 11 is an isometric view of an embodiment of an offboard stabilization system having a circular cross-section;

FIG. 12 illustrates expansion of embodiments of offboard stabilization systems in a greenhouse environment;

FIG. 13 illustrates cross-sectional views of embodiments of dual stabilization systems;

FIG. 14 is a cross-sectional view of another embodiment of a dual stabilization system;

FIG. 15 illustrates a small ducting stabilization solution for young crops; and

FIG. 16 illustrates a large ducting stabilization solution for old vine crop without leafy canopy.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Aspects and embodiments disclosed herein are generally directed to systems and methods for mechanically stabilizing plants, for example, vines to facilitate the harvesting of crops, for example, fruits from the plants with a robotic harvester. The aspects and embodiments disclosed herein may be utilized with any of the robotic fruit harvesting systems or aspects of robotic fruit harvesting systems disclosed in any one or more of PCT Application Serial Nos. PCT/US2020/018285, PCT/US2020/018395, PCT/US2019/039254, PCT/US2020/018392, PCT/US2021/020476, or PCT/US2021/014201, or U.S. Provisional Patent Application Ser. No. 63/170,232, each of which being incorporated herein by reference in its entirety for all purposes.

Aspects and embodiments disclosed herein include systems and methods for enhancing the ability to robotically harvest crops by passively or actively stabilizing the environment to allow for more accurate picking. One embodiment includes onboard (on the robotic system) stabilization features that engage with the plant vines to prevent swaying. Another embodiment includes a ducted structure or other stabilizing method installed in the crop environment, e.g., either behind or in front of the actively picked crop and stretching up to the length of an entire row. This offboard feature can serve as a stabilizer to reduce vine/crop sway, while also serving as a method to improve the quality of the computer vision acquisition by providing a uniform background surface, as well as providing a “backboard” to funnel or bounce fruits in the correct direction for harvesting. There are further synergies to be gained with the off-board stabilization by integrating a ducting solution that allows for dispersal of CO₂, generation of a thermal gradient for heating, or over-pressurizing the greenhouse that allows for increased efficacy of the crop growth cycle along with enhanced pest control. Another embodiment includes combinations of both the onboard and offboard stabilization features to give an optimal scenario for high speed and accuracy robotic harvesting. Employing both features at once allows for a full “pinning” of the vine to prevent motion from both directions, maximizing the stability throughout the environment.

Many of the disclosed embodiments below discuss the use of a series of physical components (wires/cables/frames/windows/ducts/etc.) to engage with the crop as a means of stabilization. To properly appreciate the functions and benefits of these embodiments some further context can be provided in terms of the plant anatomy components that guide certain design decisions across these embodiments. In a traditional Venlo greenhouse, plant roots are typically mounted on top of a gutter structure that serves as an irrigation run-off path. This gutter structure could be hanging from the ceiling or mounted to the floor with stands. These plant bases/roots grow upwards, following a guiding rope that attaches to an upper trellising wire. As plants age, the main vine gets longer and longer, which eventually gets held in a hook attached next to the gutter as the crop is leaned and lowered. Through crop care maintenance, there is a middle-zone of the crop where the vines are de-leafed, providing easy access to the picking-zone (whether human or robot). Above this zone is the canopy, a section where new growth of the crop happens that has more dense foliage.

Aspects and embodiments of the stabilization systems and methods disclosed herein may reduce plant movement within the active picking zone, while not hindering the ability for the robotic gripper to access the fruits and vegetables. Many of the frame or window variants of stabilization warrant size constraints that start at the gutter on the lower side, and end at the picking-zone/canopy transition zone at the higher side. The width of these windows/perimeters/frames shall be wide enough to not minimize the working range of the manipulator arm or inhibit the vision system. Some stabilization solutions involving cables may occupy the active picking zone. These embodiments have value in maintaining a small footprint as to not impede the effectiveness of the gripper. The spacing or pitch of these cables within the picking window may be determined based on the plant anatomy of the specific varietal being worked on. A truss of tomatoes grows off of a main vine. Each of these truss connections to the vine can be considered a “node”. The typical picking zone may incorporate five nodes per vine.

To maximize stabilization effects, an internodal distance or pitch can be established for the cables, wherein at least four cables may have an equal distribution of coverage to contact each of the trusses present in the picking window for a vine with five nodes. This may translate to a cable located every 6-12″ within the crop zone. For certain crop conditions, even tighter spacing of cabling may be beneficial. These cables/bungees may be installed in a horizontal, vertical, diagonal, or netted/webbed/interwoven orientation, depending on the crop varietal. For further definition of cable-related stabilization within the picking zone, the following considerations should be accounted for. The diameter of the cabling may be between 0.010″-0.125″ in diameter to afford the best engagement while limiting disruption of the gripper as well as reducing the effect on the crop itself. A variety of materials can be used for these cable stabilizers, but there has been an emphasis on semi-elastic properties that allow for strong tension against the crop while also having some give while being interfaced by the manipulator. The semi-elastic or clastic nature of the cables helps to dampen the motion of the plant matter, and some embodiments may involve the use of a tensioning element or adjuster. The elasticity of the cables also allows a finessed balance of stabilization while not damaging the plant environment. A singular end attachment bar may be used to terminate the series of cables on the same plane so that it allows for easier deployment or removal from the environment. A low friction cording such as nylon, or a combination of nylon reinforced with aluminum or polymer materials such as those used in trimmer line may have value. Bungee cording made of materials such as synthetic or natural rubber also performs well, maintaining a consistent stabilizing force throughout movement in the system.

One embodiment includes a mechanism mounted to the robot known as an onboard stabilizer. Onboard stabilization allows for local application of stabilizers to the most critical portion of the row as the robot is operating within a controlled agricultural environment. This localized stabilization doesn't affect a large portion of the crop environment outside the robot, allowing for different human/non-human crop tasks to take place simultaneously within the same row. Traditional Venlo greenhouse cultivation of tomatoes entails a process called leaning and lowering, where vines curve in a diagonal manner away from the base of the gutter until they reach their termination point on the hanging wire in the air. This curved vine zone exists for the majority of the crop's lifecycle and may be addressed with the disclosed onboard stabilization systems and methods. When solutions are deployed that engage with the upper portion of the crop, a horizonal extension may allow for sufficient stabilization of the vines that translates through to the active picking zone.

Onboard stabilization can take several different shapes and forms and can occur at several different locations relative to the row and picking height. This allows for different levels of compliance to the amount of stabilization the picking zone is experiencing while being harvested.

Onboard stabilization may include anything that prevents vine crops from moving towards the robotic harvester in undesirable ways. The stabilization limits movement in one direction while also slowing down and reducing the settling time of any crop swing that does become induced in the environment. Stabilization features can consist of either rigid or compliant structures, or a combination of both, and can include either passive or active engagement or a combination of both. Onboard stabilization typically occurs outside of the picking zone of the robotic harvester, i.e., to the top, sides, and bottom of the picking zone, but could also be deployed inside of the picking zone provided there is no interference with harvesting methodology. Embodiments of the disclosed stabilization methods ensure that the vine and/or individual trusses are stabilized and remain motionless while the harvester interacts with the environment and introduces movement. The reduction in movement makes the environment more predictable and static even when external excitations are present.

An added benefit to onboard stabilization is the control of the distance that the vine crops rests away from the robot. This distance could be set manually in a passive set up to precisely align the distribution of harvestable fruit as crop environments change. An active method could even adjust for changes within an area, for example, displaced or curved rails, to allow for automatic control and adjustment of the stabilization. Adjusting the location of the crop also reduces the distribution of fruit depth making the picking depth more predictable and consistent.

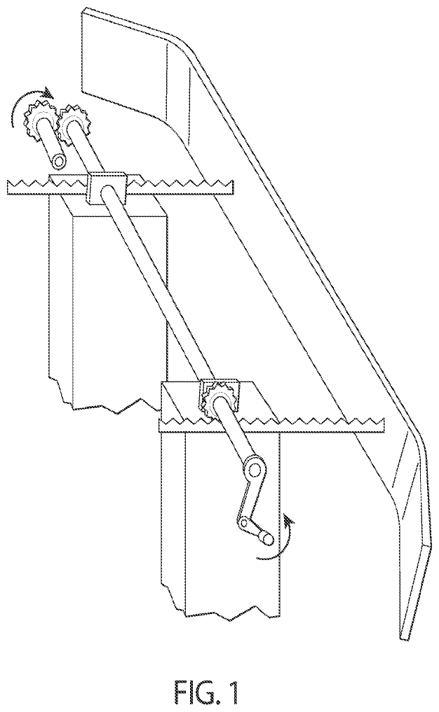

Embodiments dealing with passive onboard stabilization may be accomplished through rigid structures, adjustable clamping locations to set depth, or use linear rails/linkage mechanisms along with springs to ensure proper consistent loading against the crop throughout the length of a variable depth row. Embodiments including active stabilization techniques may involve the use of pneumatics, electric motors, or any other actuator in combination with a solution set of linear rails, manual or motorized rack & pinion extension/retraction, linkages, or mechanical cams or guides to that allow for adjustable set points during operation. These solutions may also enable faster maneuvering to exit a row by retracting any devices that would engage with crops. One example of what these mechanisms could look like, shown with both a manual and automatic extension mechanism can be seen in FIG. 1.

Top mounted row stabilization has the added benefit of structure above the picking zone. Materials and geometries could be chosen that provide shade or diffuse lighting over the picking area of the harvesting robot. This allows for more consistent lighting throughout the course of a day. Active shading could also be included for finer control over the lighting conditions. Any of these onboard stabilization techniques must employ the use of gradual radii along edges and other streamlining features that resist individual fruits or trusses from getting accidentally removed from the crop environment during operation. Tall and wide structures proportional to the picking zone help to stabilize a wider area surrounding the active picking zone and apply less pressure on the crop itself. An additional add-on to onboard stabilization elements is considerations for cleanability from an integrated pest management (IPM) perspective. To reduce the chances of transmitting any disease and/or pests present in the environment across different zones of the greenhouse, methods may be deployed to provide a consistently clean work-surface. One embodiment is incorporating a heat-shrunk plastic (PE, PVC, etc.) cover over the engagement surfaces that could be easily removed for cleaning. These protections can also limit the corrosive impact of the acidic plant matter build-up on the robot structures.

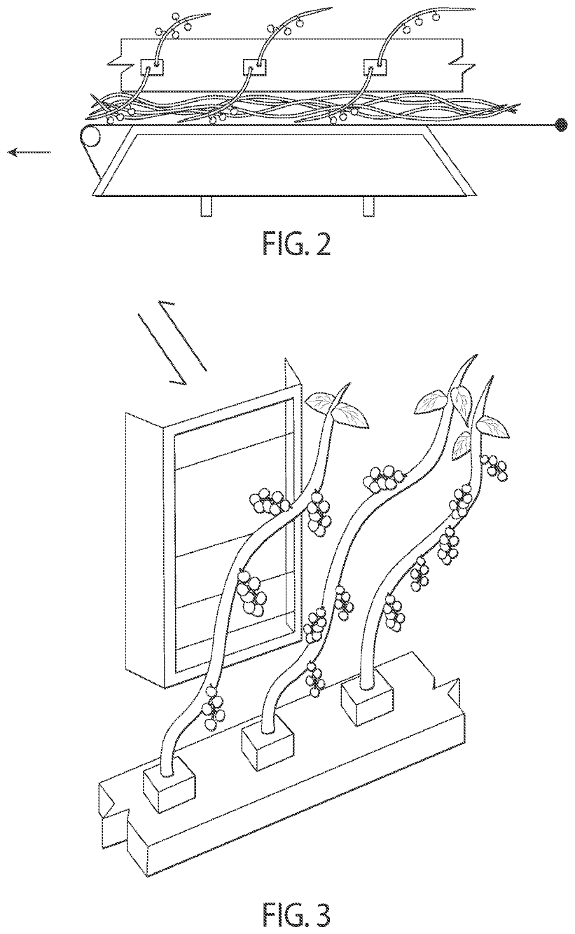

The harvesting robot can have additional on-board stabilization that would contact fruits and vines as desired. There would be different kinds of on-board stabilization methods that could interact with the fruits and vines. Systems such as spool(s) of wire(s)/cable(s) placed in different positions/orientations that would deploy as the robot moves down into a row of crops. The mechanism would use spring-linkages, tensioning pulley(s)/roller(s), pneumatics, or motorization to create and or maintain tension within the wire(s)/cable(s) as the robot picks objects in row. The wire(s)/cables(s)/bungee(s) would be pressing against the crop to reduce swaying motion. When the robot has completed picking the desired number of items, the tensioning mechanisms will reel the spool of wire(s)/cable(s) back into the harvesting robot as it exits the row. This allows for clean and automatic uninstall during autonomous picking. An example of this mechanism can be seen in FIG. 2.

Another embodiment of on-board stabilization would be a mounted system that interacts with the fruit as the robot moves. This system may include a moving panel/or plane/window/frame that can extend and retract as the robot is moving throughout the crop row. The extending panel(s) may have a window cutout(s) with various patterns of wire(s)/cable(s)/bungee(s) or netting to help stabilize the crop as the robot picks fruit. The panel can be a plane that is constructed from items such as wire(s)/cable(s), sheets, rods, or channels to engage with the crop. These solutions within the picking zone should not obstruct access to the fruits by the robotic harvester, so wire-based solutions lend themselves well here. Side panels outside of the active picking zone could also be included to reduce sway in the system since the vines are leaned at an angle and do not grow straight upwards. The benefit that this method provides is that it would press against fruit and crop that have no backing. This would dampen vine sway and can be used throughout the entire crop life cycle. An example of this method and how it moves into the picking zone can be seen in FIG. 3. Cables and/or other physical components may not be required to occupy the picking zone, where a frame itself solely engages with the crop perimeters for stabilization. Several different versions of this external window geometry exist to facilitate improved stabilization and interaction with the plant environment. One could use a flat surface, a tapered surface that has blunt protrusions, or additional spikes/rods, where all these methods provide a method to further intertwine/prevent movement with the environment upon extension. One could use a sticky/grippy surface texture on the flat or tapered geometries that further limits sliding of the plant matter against the structure.

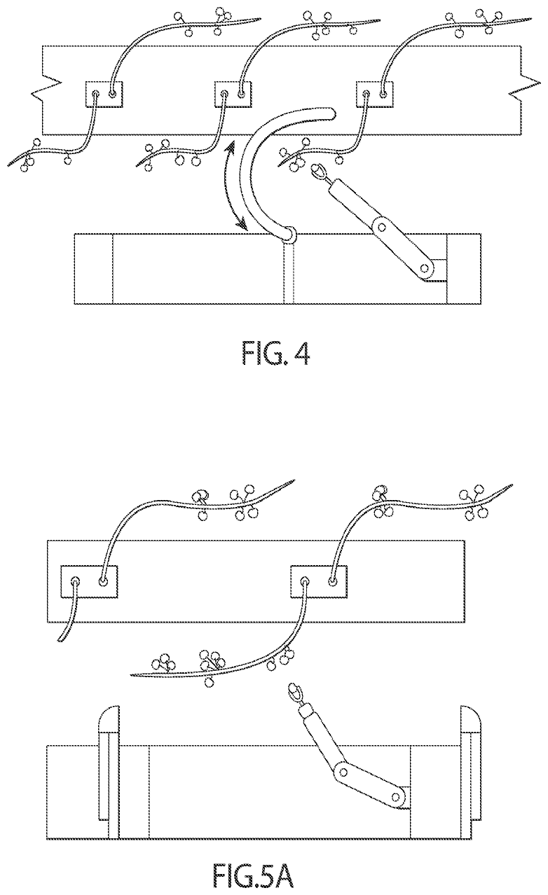

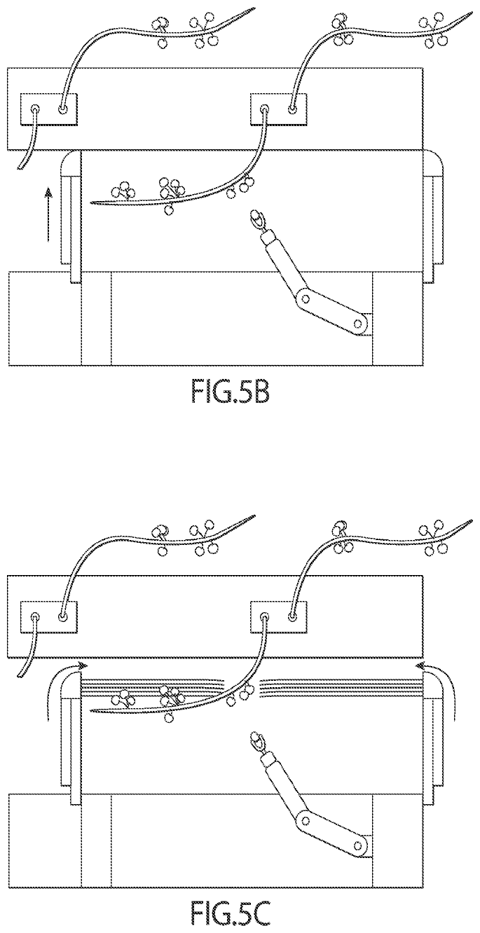

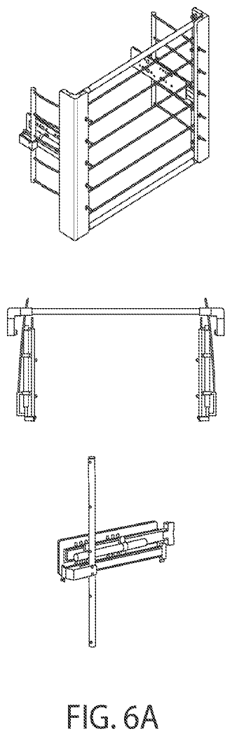

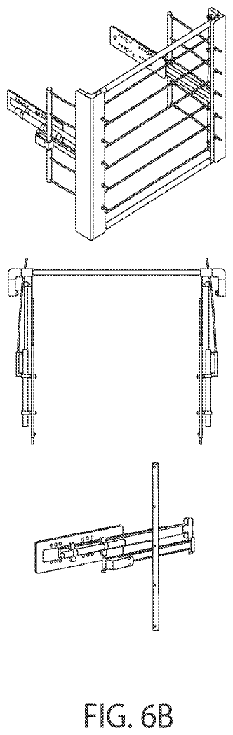

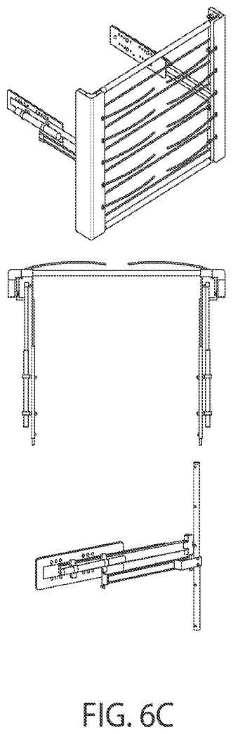

Actuation of an on-board stabilization sub-system is not just limited to linear motion. In some embodiments, a circularly actuated fingered moving structure may interact with crops behind the vines and trusses. The circular fingers, or comb, could engage with the crop by pivoting about a point, a series of joints, telescoping, four-bar linkages, or different degrees of translation. An example of this method is shown in FIG. 4 illustrating a top view of the system in action. The fingers or combs could also follow a curvilinear path that allows for a smooth interdigitation of fingers/tines/tongs into the crop environment. These times may have a small profile (<0.25″ tall×<0.080″ thick) and may be formed of spring steel that would non-destructively engage through or behind individual trusses to provide stabilization. There is a beneficial means for achieving this interdigitation through using a two degree of freedom movement, an extension into the crop environment, and then an additional linear extension that translates the spring steel tines through a curved guide that deploys them into the crop at a 90-degree angle. Rotational deployment of a clock spring may also be used to save system space. The advantage of this is minimizing the surface area of on-board stabilization on entry into the picking zone while still allowing for support on the rear-side of the crop. An example is shown in FIGS. 5A-5C. An example of a dual onboard stabilization system is shown in FIGS. 6A-6C.

A harvesting robot fully built up with onboard stabilization would be much more streamlined and allow for seamless entry into and down the length of the row. Different forms of paneling could bridge across the robot for further stabilization. Angled stabilization in the front and rear of the robot would gently push any vines hanging in the middle of the row back to the desired position, resting against the row stabilization. This also prevents snags and other unwanted interactions of the harvesting robot with the environment. These additional stabilization features may also be used to enhance the picking environment. For example, one could use a rotational, curvilinear, or linear translation motion path of the deployed stabilizer to push upwards at the upper portion of the picking zone to move any foliage/leaves higher in the air, effectively providing a larger picking zone that could be worked on.

Some examples of onboard stabilization systems may include actuated rods mounted to the robot carriage that close together to envelop a truss/vine, a “V” shaped brush/slider that gets deployed with pneumatics off of the side of the carriage, and passive compliant plastic tubing jutting out from the robot carriage that applies slight pressure to the vines as the carriage goes up and down but does not induce a catch point when moving.

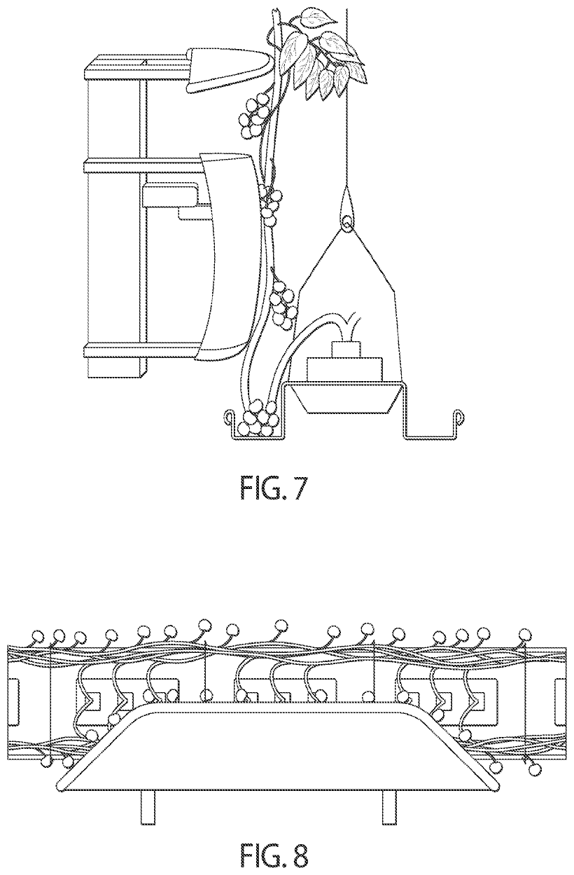

FIG. 7 is a side view of one embodiment of an onboard stabilization system, and FIG. 8 is a view of the onboard stabilization system from the top.

Another embodiment includes an addition to traditional greenhouse environments by adding an offboard stabilization structure. Offboard stabilization allows for crop stabilization on the entire row as the robot is operating in front of the crops, for example, tomatoes. The offboard stabilization system and method stabilizes crops as they are being picked off a vine while being suspended in air. Because of the busy and varied nature of a greenhouse, offboard stabilization systems should not impact daily operation and should be collapsible or retractable to remain out of way whenever not in use.

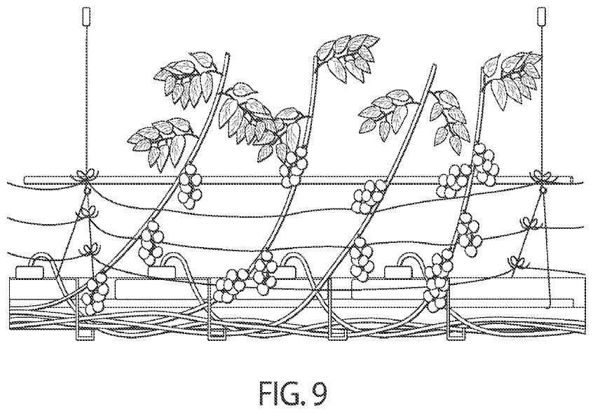

An additional mode of stabilization can be envisioned coming from the center of the row, or from the outside relative to the picking zone. Stabilizing crops on this side has a different set of requirements such as retaining access to picking fruit off the vine. Several solutions can be envisioned here centered around cable/wire-based solutions. These methods work by entangling the crop and trusses with their neighbors and damping the local effect that robotic picking has on an area. Wires can be wound in front of the crops and connect to support columns, water heating pipes, gutter hanger suspension, or any other rigid part of the environment. The wires can be strung horizontally, diagonally. or vertically above the vine bundles and can vary in number, material, and size. The wires can also be shaped into a net of various opening sizes depending on the specific application of robotic picking. Cable(s)/wire(s) can be attached and removed before robot operation. The attachment points would spread across the row of crops and could be positioned at various angles and span in different directions. An example of a horizontal wire-based off-board stabilization can be seen in FIG. 9. Combining a forward and rearward off-board stabilization solution can provide the most rigid form of stabilization creating a highly structured and predictable environment for robotic picking.

Offboard stabilization can take different shapes and forms across the entire crop row. The stabilization can include rigid or compliant structures located behind or in front of the crop. Because the system is not attached to the harvesting robot there can be constant stabilization acting on the entire row of crop. The system maybe designed to be collapsible and stored out of the way. As the offboard stabilization system expands it will contact the vines and restrict their range of motion. Both the vines and tomatoes will rest on the expanded offboard stabilization system, allowing for stabilization and reducing the amount of swaying action that may occur as the tomatoes are being picked by the robot. By increasing the amount of contact the vines make with adjacent crops and additional stabilization structures the system become more rigid when disturbed. Due to the compliant nature of the structure of the offboard stabilization system any interference or intrusions into the structure will not impact the robot, as the structure will passively move out of the way.

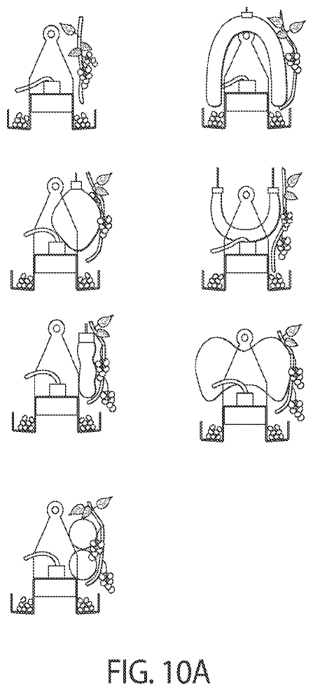

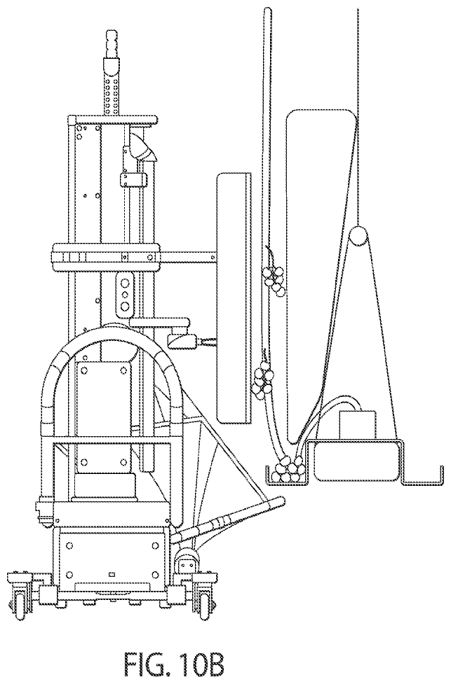

FIG. 10 displays a few of the many cross-sectional profiles of offboard stabilization system structures that could stabilize from the center of the gutters or from the inside relative to the picking zone. The structures would expand or deploy to a certain position that pushes the tomatoes and vines outwards and provide a surface for the tomatoes to rest on. Not all solutions entail physically moving the crop towards the robot and could passively engage just enough to provide support to the existing fruit location. There are objects such as heating pipes, water distribution tubes, and wire hanger supports, that limit the geometry that can be selected. This also allows for different shapes to be chosen based on different environmental factors. These shapes will be retracted or deflated when not in use and can be sorted in place or quickly pulled out of the environment entirely. The shapes can be separated to have separate inflatable sections, where one section can inflate, and the rest of the material will rest behind or on the crop and act as a back rest. The shapes can be installed on a suspended beam or inserted in the empty space near the center of the gutters to allow for case of install and removal of the offboard stabilization. To make these shapes specific stitching patterns can be used to inflate the structure to the proper shape, or external cables or stiff wires can be used to restrict the structure into a more beneficial environment.

Additional features can also be designed into the patterns to account for environmental features such as gutter hanger or stands, water heating pipes, building support pillars or alternative existing crop structures. These features can include slits that allow the structure to be secured in place or pass underneath/above environmental hazards. More complicated patterns and inflation methods could also allow for modularity in the inflatable design by only inflating part of the way down a row to allow for simultaneous harvesting and crop care task to take place. Upper and lower portions of an inflatable structure could also be inflated depending on the crop structure week to week and where the ripe fruits fall within the picking window. Uninflated portions of the tube could remain in place to continue to block fruit from falling out of the backside of the picking zone.

Because the offboard stabilization is deployable, it is also collapsible, and the crop environment can be returned to its normal state to allow for different crop care activities to take place. The offboard stabilization can then be re-deployed when harvesting is scheduled to take place providing minimum intrusion to the environment and greenhouse operation. Several different deployment methods are available including temporary inflation of a sealed structure, continuous inflation of an open structure, mechanical actuation, and elastic actuation.

Although the offboard stabilization methods may entail rigid or flexible solutions, the use of an inflatable duct may be of value for the possibilities of other use-case benefits. One of those benefits could be combined in conjunction with existing Venlo style greenhouse technologies such as CO₂ distribution systems. These systems force CO₂ rich air to disperse throughout a greenhouse to slightly raise the percentage of CO₂ available to plants, allowing them to incur a higher rate of photosynthesis. Since the technology already exists and has been deployed at a large scale it would be simple to duct the CO₂ through the row stabilizer to serve as a dual-purpose device. This combined method would reduce facility construction costs as well as provide an optimal way to maintain desirable CO₂ levels between 800-1300 ppm that facilitate the strongest growth response in the crop.

Another benefit to the use of a ducted or inflatable stabilization solution would be a combined ability to induce a controlled thermal gradient within the greenhouse that ensures optimal growing conditions across the base slab/root structures all the way up through the vines to the flowering section. Within a greenhouse, heat will affect the water content of soil, its nutrients, and therefore the ability for nutrient uptake by the plants. It has been observed that at low soil temperature, nutrient uptake by plants decreases because of high soil water viscosity and low activity of root nutrient transport. In addition to this, an increase in soil temperature improves root growth because of the increase in metabolic activity of root cells and development of lateral roots. For this reason, the addition of heating at the root zone can increase fruit yield and overall fruit weight. Likewise, proper environmental conditions are important for successful pollination and fertilization at the top of a vine crop like tomatoes. For instance, if the temperature is too hot, the pollen grains are more likely to be damaged or dried out and may not fertilize or have enough ability for pollen tube growth. It is important in a greenhouse setting there are no microclimates and therefore the air is homogenized. It is desirable to consistently avoid areas of high or low temperature, humidity, or carbon dioxide. This will also help to reduce the boundary layer (the physical still air layer around the leaf) so that proper gas exchange and transpiration can occur at the top of the canopy. This heat distribution control method may allow for facilities to offset the need for integrated hydronic heating (the use of floor mounted rails for distribution of heat), inter-crop heating pipes, as well as cool-air polyethylene tubing at the top of the crop to achieve the same results, which may allow for reduced costs and optimize maintenance schedules while opening the landscape for geometry selection with this solution.

Yet another benefit for using a ducted or inflatable stabilization solution is a combined ability to force a positive-pressure environment from within the greenhouse in a semi-enclosed Venlo system. This over-pressurized system would allow for the potential mitigation of harmful pests and insects that damage crop yields such as aphids.

To provide for desirable thermal gradients, CO₂ distribution, and greenhouse pressurization for the reasons above, one could incorporate a bifurcated or layered ducting approach that separates the duct into different gas or pressure zones throughout the length of the crop row. This double (or more)-lined “annular” structure helps ensure that airflow is even and perpendicular to the length of the tube along with ensuring uniform pressure and stiffness throughout the length. Aside from the geometry and layering approach, material selection is important for a successful implementation. For FDA food compliance, improving cleanability, reducing chances of developing mildew, mold, or other detrimental contaminants, a material such as polyethylene (PE) or polypropylene (PP) plastic may be beneficial. In terms of cleanliness, these material selections should be chemically inert to chemicals used within agricultural facilities, as well as remaining stable in high-moisture environments. Furthermore, different material coatings may be applied such as platinum compounds/etc. that could aid in resisting disease or other bacterial buildup. Additional material selection enhancements can be made to aid the structure in being puncture-proof or resistant to enable efficient farm maintenance operations such as harvesting, de-leafing, and de-suckering in which cutting implements may be utilized.

Other materials that may be utilized for the inflatable structure include nylon, ripstop nylon, ripstop polyester, Gore-Tex™ fabric, and/or Dyneema® fabric. In addition to the material selected, the weight or material thickness of the film or fabric should be considered for both case of installation and removal, as well as the resistance to large tears that would deflate the system. While most of these materials are reasonably low friction, care should also be taken during the selection to provide proper interaction with the robot picking arm end effector fingers. There is a desire to maintain a low friction surface so that the fingers do not tear, bind, or stick to the inflatable as a pick is being attempted.

The area that the offboard row stabilization system is designed to occupy is generally empty space. By filling the space behind the vine crop with a compliant structure, the offboard row stabilization system serves another important role by deflecting fruit away from this otherwise empty space. The fruit is directed back towards the harvesting robot when picked and the structure blocks off both the gutter and the vine bundle below the crop. This works well with fruit collection systems onboard harvesting robots that capture fruit once it is off the vine. Adding structure to act as a backboard can also be separated as a function of crop stabilization. Additional backboard elements can include, but is not limited to, a flat panel extending vertically above the roots, a tent-like structure suspended from a water heat pipe. Both ideas have numerous possibilities in geometry and material, and can be made to be rigid, elastic, or compliant as a backboard reflective medium.

The deployed structure also improves computer vision by providing a consistent and predictable background to measure against. The images captured by the computer vision can leverage the offboard stabilization because the relative positions of the target fruit and the background remain consistent. The texture, color, pattern, and material of the background stabilization can be controlled as well. This allows for control of the reflectivity of infrared (IR) and visible light to enhance the ability of the amount of light available to the computer vision system. For instance, a white, rough textured stabilization structure allows for more visible light to penetrate the dense foliage and reflect into the row for the vision system to sense. A rough texture provides a contrast in IR depth sensing compared to a smooth surface which can be difficult for depth sensors to detect accurately. This also enables modulating the saturation levels of the sensor.

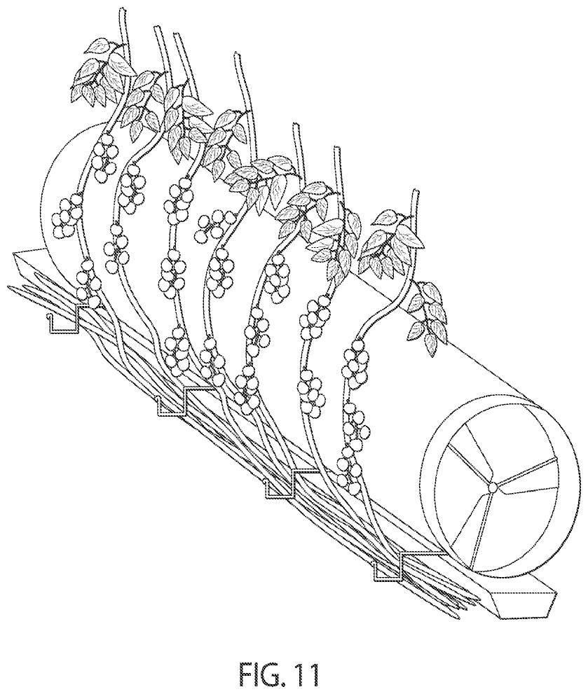

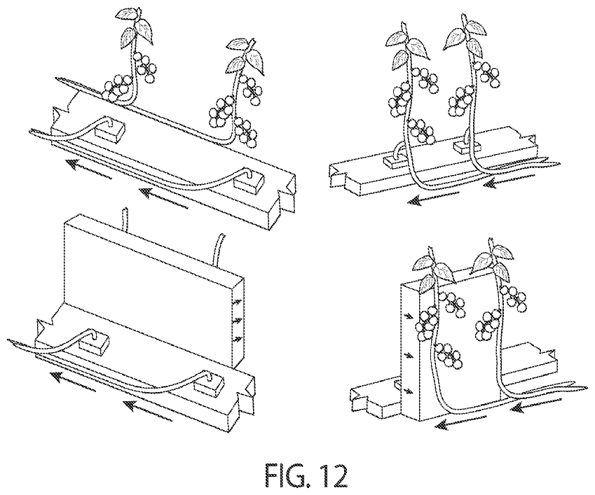

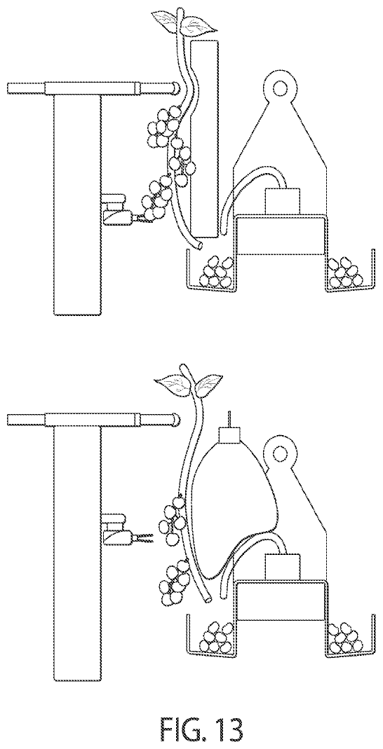

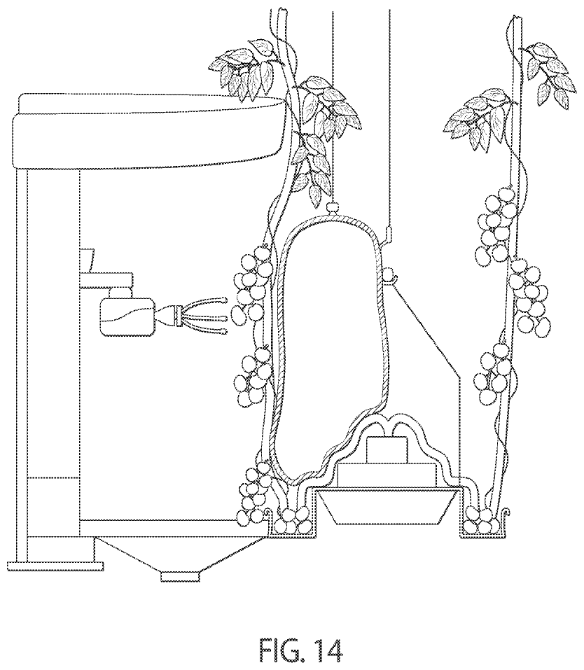

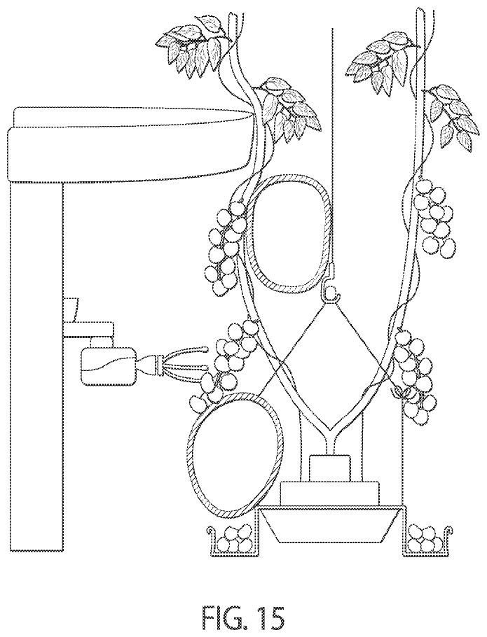

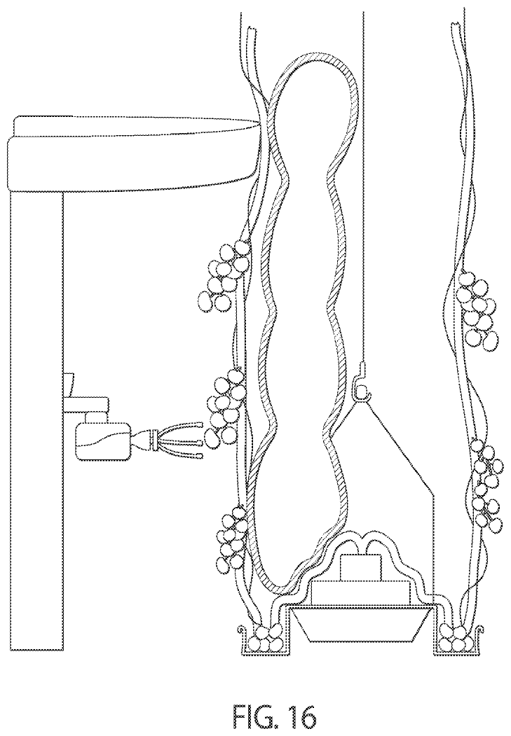

FIG. 11 is an isometric view of an embodiment of an offboard stabilization system having a circular cross-section. FIG. 12 illustrates expansion of embodiments of offboard stabilization systems in a greenhouse environment.

Another embodiment includes a combination of both methods of onboard and offboard stabilization. The offboard stabilizer will have an object expand or deploy and push the crop outwards towards away from the vine bundle and gutter while the robot's onboard stabilizer will push the vines and fruit inwards towards the expandable object. The on-board stabilization can include wire guides, perimeter frames, side wall, and/or top and bottom actuation, and can be actuated or passive. The deployable object of the offboard stabilizer is compliant enough that even if the onboard stabilizer compresses the vine against the offboard stabilizer, there would be no damage done to the crop or vines. The combined stabilization method would create a more controlled picking environment for the harvesting robot. The vines and trusses could be fully encapsulated and confined to a narrow picking zone between on-board stabilization, which ensures that fruits remain in a predictable and consistent location.

Each of these solutions can be combined in different ways and forms, both on-board and off-board, to optimize around the lifecycle of vine crops. Young crops grow straight upwards until the vines are tall enough to be lowered and leaned to one side of the root system. Throughout this process leaves are trimmed, and trusses are picked clean resulting in a bare vine that eventually comes to rest in the vine hooks near the gutter. This dramatic and varied change in the physical set-up of the crop means that the desired solution might change throughout the lifecycle of the crop. For example, when the crop is younger and hasn't yet been lowered down to the vine gutter the crop is naturally more stabilized as there is a shorter distance between the roots in the gutter and the top of the vine. However, in this state the trusses hang very low and modified stabilization schemes can be envisioned. Outside of the picking zone inflatable stabilizers can be added where the vines normally rest in the hangers. This takes up area that is normally unaccusable to stabilizers without restricting picking access to the fruit. A roughly 10″ inflatable structure can fit external to the crop with another 10″ inflatable structure on the inside. In this young crop scheme, external wire stabilization becomes more valuable as it restricts fruit movement at a truss level where this would normally only be possible with internal structures. A more average, middle-aged crop does not have the same stabilization conditions that make off-board wire stabilization as effective at a very young age.

Older crop poses its own challenges, especially once the top of the vines are cut off and the crop stops growing vertically. In this state crop stabilization becomes even more important as there are no vegetal leafy structures at the top of the crop to naturally restrict and dampen movement. This leaves the crop unhampered and free to move about resulting in the desire for larger and more imposing stabilization structures as compared to the ‘nominal’ middle-aged crop.

Unless the context clearly requires otherwise, throughout the description and the claims, the words “comprise.” “comprising.” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A crop stabilization system for a robotic crop harvester, comprising:
at least one of an onboard stabilizer carried by the robotic crop harvester and an offboard stabilizer uncoupled to the robotic crop harvester, the one of the onboard stabilizer and offboard stabilizer configured to mechanically engage a portion of a plant and reduce a tendency of the plant to move while the robotic crop harvester harvests the crop from the plant.

2. The crop stabilization system of claim 1, wherein the at least one of the onboard stabilizer and offboard stabilized includes a removable cover.

3. The crop stabilization system of claim 1, wherein the onboard stabilizer includes one or more cables configured to extend and contact the portion of the plant.

4. The crop stabilization system of claim 3, including a cable deployment mechanism configured to deploy the one or more cables against the portion of the plant during harvesting of the crop and to retract the one or more cables away from the portion of the plant and toward or into a body of the robotic crop harvester while the robotic crop harvester is not harvesting the crop.

5. The crop stabilization system of claim 4, wherein the one or more cables are mounted in a frame.

6. The crop stabilization system of claim 2, wherein the at least one of the onboard stabilizer includes a finger or comb configured to pivot into place on an opposite side of the portion of the plant from a body of the robotic crop harvester during harvesting of the crop.

7. The crop stabilization system of claim 6, wherein the finger or comb is included in a set of interdigitating fingers or combs.

8. The crop stabilization system of claim 1, wherein the offboard stabilizer includes a net configured to be attached to a row of plants prior to harvesting crops from the plants and removed from the row of plants after harvesting of the crops.

9. The crop stabilization system of claim 1 wherein the onboard stabilizer is configured to push the portion of the plant away from the robotic crop harvester.

10. The crop stabilization system of claim 9 wherein the onboard stabilizer includes a passive body extending from the robotic crop harvester configured to engage the portion of the plant when the robotic crop harvester comes into position to harvest the crop from the plant.

11. The crop stabilization system of claim 9 wherein the onboard stabilizer includes an active system that extends and retracts a surface configured to engage the portion of the plant away from and back toward the robotic crop harvester.

12. The crop stabilization system of claim 9 wherein the onboard stabilizer includes an active system having articulating rods configured to engage the portion of the plant.

13. The crop stabilization system of claim 12 wherein the articulating rods are configured to hold the portion of the plant in place between the articulating rods when engaged.

14. The crop stabilization system of claim 8 wherein the onboard stabilizer is configured to push the portion of the plant against the offboard stabilizer.

15. The crop stabilization system of claim 8 wherein the offboard stabilizer is configured to push the portion of the plant toward the robotic crop harvester.

16. The crop stabilization system of claim 15 wherein the offboard stabilizer is configured to deploy when the robotic crop harvester comes into position to harvest the crop from the plant and to retract when the robotic crop harvester moves away from the plant.

17. The crop stabilization system of claim 16 wherein deployment of the offboard stabilizer includes temporary inflation of a sealed structure.

18. The crop stabilization system of claim 16 wherein deployment of the offboard stabilizer includes continuous inflation of an open structure.

19. The crop stabilization system of claim 16 wherein deployment of the offboard stabilizer includes mechanical actuation.

20. The crop stabilization system of claim 16 wherein deployment of the offboard stabilizer includes elastic actuation.

21. The crop stabilization system of claim 8 wherein the offboard stabilizer includes a rough textured surface.

22. The crop stabilization system of claim 8 wherein the offboard stabilizer includes a compliant surface.

23. The crop stabilization system of claim 22 wherein the compliant surface of the offboard stabilizer is configured to direct a crop separated from the plant toward the robotic crop harvester.

24. The crop stabilization system of claim 1, wherein the offboard stabilizer includes a plurality of cables configured to be attached to a row of plants prior to harvesting crops from the plants and removed from the row of plants after harvesting of the crops.

25. The crop stabilization system of claim 1, wherein the offboard stabilizer includes a plurality of cables or wires and the system lacks an onboard stabilizer.
